(19) United States
(12) Patent Application Publication
(10) Pub. No.: US 2010/0304928 A1
(43) Pub. Date: Dec. 2, 2010

(54) METHOD AND APPARATUS FOR DIRECTLY ENTERING NEUTRAL IDLE DURING A GARAGE SHIFT

(75) Inventors: Ronald F. Lochocki, JR., Ypsilanti, MI (US); Sindu Sebastian, Ann Arbor, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/474,750

(22) Filed: May 29, 2009

(51) Int. Cl. F16H 61/02; G06F 19/00

(52) U.S. Cl. 477/116; 701/58

(57) ABSTRACT

A vehicle includes an engine, a multi-speed transmission with a neutral idle (NI) mode capability, and a controller. The controller allows direct entry into the NI mode during a garage shift (GS) event. One clutch is actuated during the GS event, and a different clutch is actuated to directly enter NI mode after completing the GS event. A method allows for direct entry into a neutral idle (NI) mode during a garage shift (GS) event using a multi-speed transmission. The method includes automatically actuating a first clutch of a plurality of clutches to complete the GS event, and a second clutch of the plurality of clutches to directly enter the NI mode after completing the GS event. The method may include holding the NI clutch at a pre-learned NI pressure during a fill stage of the GS clutch, and varying a turbine pull-down rate to provide different GS shift feels.

### TECHNICAL FIELD

The present invention relates to the automatic shift control of a vehicle transmission having neutral idle functionality.

### BACKGROUND OF THE INVENTION

Vehicle transmissions are designed to transmit torque from an engine to the drive wheels in order to propel the vehicle at a relatively wide range of output speeds. The engine includes a rotatable output shaft that may be selectively connected and disconnected from a transmission input shaft as needed. When the vehicle is configured with a manual transmission, a foot-operated clutch pedal may be selectively actuated to allow the driver to shift gears and/or to place the transmission into a neutral state. In an automatic transmission this connection is provided automatically via a hydrodynamic torque converter assembly.

A hydrodynamic torque converter assembly or a torque converter includes an impeller or pump, a turbine, and a stator. The torque converter is filled with oil. The pump, which may be bolted to a rotating flywheel portion of the engine to continuously rotate at engine speed, discharges fluid into the turbine. A stator redirects the fluid discharged from the turbine back into the pump. The turbine in turn is connected to the transmission input shaft. The torque converter as a whole thus enables variable fluid coupling to occur automatically between the engine and the transmission, thereby allowing the vehicle to slow to a stop without stalling while also allowing torque multiplication at lower vehicle speeds.

In some torque converter designs a lock-up torque converter clutch (TCC) is used to selectively lock the rotating pump to the rotating turbine above a calibrated threshold lockup speed. Below this speed the torque converter allows an increasing amount of slip to occur across the torque converter as vehicle speed decreases, ultimately reaching a maximum slip level when the vehicle speed is zero. Regardless of whether a TCC is used, this variable slip capability allows the engine to continue to rotate when the vehicle is idling in certain transmission settings or states, e.g., in park (P), neutral (N), or in a drive state, i.e., drive (D) or reverse (R). In some transmission designs operating in a neutral state during a drive detent position, i.e., when the vehicle is at a standstill in drive or reverse and the engine remains running, the transmission may be automatically placed in hydraulic neutral or a neutral idle (NI) state to save fuel relative to retaining the torque converter a torque multiplication mode.

### SUMMARY OF THE INVENTION

Accordingly, a method is provided for automatically and directly entering neutral idle (NI), i.e., a hydraulic neutral state, in a vehicle having a multi-speed transmission with one clutch serving as a garage shift (GS) clutch and another serving as a neutral idle (NI) clutch. That is, the method controls clutch operation when an oncoming clutch in drive/reverse, which is the GS clutch, is not the same clutch that is slipping, which is the NI clutch, when the transmission is in drive/reverse, as well as in an NI mode, unlike conventional vehicles with NI capability that use a single clutch as both the NI clutch and the GS clutch. The method is computer-executable, and may be stored in memory of an onboard controller and automatically executed to shift a vehicle transmission into NI during a GS maneuver. The method may be used in a multi-speed transmission, e.g., 6-speed and 8-speed transmissions of various configurations, to provide a tunable, smooth, and rapid response and potentially customizable shift feel, with a reduced emissions hydrocarbon spike depending on the particular level of tuning.

When leaving park/neutral (P/N) the NI clutch is staged to a pre-learned pressure while the oncoming GS clutch is filled, and optionally begins to transition to pulling down turbine speed. Once clutch fill has ended and optional turbine speed pull down has begun, the NI clutch may be controlled in a closed-loop control mode while the GS clutch is sent to line pressure and held at this pressure. The NI clutch continues in closed-loop mode until the driver launches the vehicle. The magnitude or depth of turbine speed pull down may be optionally tuned during vehicle calibration or service, with the level of the resultant hydrocarbon spike corresponding to the level of turbine speed pull down.

In particular, a vehicle includes an engine and a multi-speed automatic transmission with a plurality of torque transfer mechanisms or clutches, either rotating or braking as set forth below. In one embodiment, the transmission includes five clutches which are selectively actuated, alone or in combination, to provide 8-speed functionality. One of the clutches is a brake clutch configured as the NI clutch, and also configured as a 1^{st}, 2^{nd}, 7^{th}, and 8^{th} gear clutch. Another is a rotating clutch configured as the GS clutch, and also configured as the 1^{st}, 3^{rd}, and 5^{th}-7^{th} gear clutch. As noted above, the NI clutch and the GS clutch are separate clutches.

The transmission may be electrically controlled by a controller having an algorithm for executing the method of the invention. The algorithm determines if the transmission is in a P/N state during certain NI conditions. If so, the GS clutch and the NI clutch are staged and filled. The NI clutch in particular is staged and filled to a pre-learned NI pressure for regulation, i.e., held at a constant fill pressure initially and thereafter regulating in a closed-loop mode. The GS clutch may be calibrated for the desired feel depending on the rate of pull down of the turbine speed. For example, three levels may be calibrated in one embodiment: (1) little feel, with minimum pull down and hydrocarbon spiking, (2) some feel, and (3) normal GS feel, with maximum hydrocarbon spiking and potential feel.

Once the GS clutch is filled, the GS clutch transitions to line pressure and is controlled in a closed-loop mode while the NI clutch is also controlled in a closed-loop mode until the driver launches the vehicle. Or, if turbine speed pull-down is calibrated as set forth above, the GS clutch may be ramped up at the corresponding rate. Control continues in this manner until the GS clutch is applied.

A vehicle is provided herein that includes an engine, a multi-speed transmission with a plurality of clutches that may be selectively actuated to directly enter a neutral idle (NI) mode during a garage shift (GS) event, and a controller. The controller has an algorithm allowing direct entry into the NI mode during the GS event, i.e., during an automatic shift from one of a park (P), a neutral (N), and a reverse (R) setting to a drive (D) setting. One of the clutches is actuated as a non-slipping GS clutch during the GS event, and another is actuated as an NI clutch to directly enter the NI mode prior after completing the GS event. As noted above, the two clutches are different devices.

A method is also provided herein for directly entering a neutral idle (NI) mode during a garage shift (GS) maneuver or event from one of a park (P), a neutral (N), and a reverse (R) setting to a drive (D) setting using a multi-speed transmission. The method uses a controller to automatically actuate a first clutch of a plurality of clutches to complete the GS event, and to automatically actuate a second clutch of the plurality of clutches to thereby directly enter the NI mode after completing the GS event. The first clutch is separate from the second clutch. In one embodiment, the method includes holding the NI clutch at a pre-learned NI pressure during a fill stage of the GS clutch. In another embodiment the method includes detecting turbine pull-down, and then varying the pull-down rate to provide different shift feels during the GS event.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having an automatic transmission and control method in accordance with the invention;

FIG. 2A is a lever diagram for one embodiment of the transmission shown in FIG. 1;

FIG. 2B is a lever diagram for another embodiment of the transmission shown in FIG. 1;

FIG. 3 is a graphical flow chart describing an algorithm suitable for executing the method of the invention;

FIG. 4A is a pressure vs. time chart of the control signals used for controlling a neutral idle and garage shift clutch of the transmission shown in FIG. 1; and

FIG. 4B is a shift type and RPM vs. time chart for the neutral idle and garage shift clutch of the transmission shown in FIG. 1 as a response to the signals of FIG. 4A.

### DESCRIPTION OF THE PREFERRED EMBODIMENTS

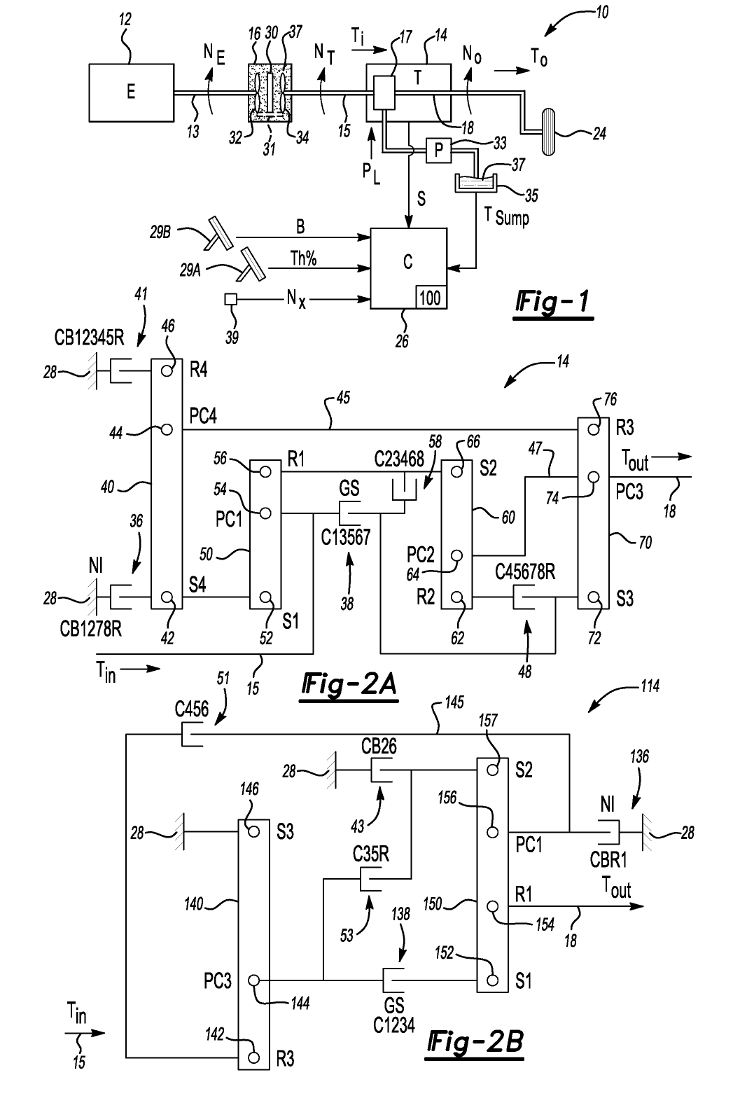

Referring to the drawings wherein like reference numbers correspond to like or similar components throughout the several figures, and beginning with FIG. 1, a vehicle 10 includes an engine (E) 12 coupled to an automatic transmission (T) 14 via a hydrodynamic torque converter assembly or torque converter 16. The engine 12 has an output shaft 13 which rotates at an engine speed N_{E}. The transmission 14 in turn has an input shaft 15 which rotates at a speed N_{T}. Transfer of an input torque (Tᵢ) to the transmission 14 occurs through the torque converter 16, as described below.

The transmission 14 also has an output shaft 18, which ultimately conveys a transmission output torque (Tₒ) that is transmitted from various clutch and gear sets 17 of the transmission 14 to thereby propel the vehicle 10 via a set of wheels 24 connected to an output shaft 18 of the transmission. A differential (not shown) may be included in the design of the vehicle 10 without departing from the intended scope of the invention. The clutch and gear sets 17 can be selectively actuated through electro-hydraulic controls powered by pressurized fluid delivered from a pump (P) 33 at a line pressure (P_{L}). The pump 33 is configured to draw fluid 37 from a sump 35, with the fluid 37 having a detectable temperature (T_{Sump}).

Within the scope of the invention, the transmission 14 may be configured as any multi-speed transmission, e.g., a 6-speed or an 8-speed transmission, having a neutral idle or NI capability as described above. As will be described in detail below with reference to FIGS. 2A and 2B, the transmission 14 has an NI clutch for entering an NI state and a GS clutch for executing a garage shift (GS), and these devices are separate. That is, the operation of the transmission 14 is automatically controlled to allow direct entry into an NI state during a GS event, defined herein as a shift from park/neutral (P/N) to drive (D), or from reverse (R) to drive (D), as is typified by a shift maneuver from a standstill when the vehicle 10 is parked.

In neutral idle (NI) the transmission 14 may be placed in a drive (D) setting while electro-hydraulic clutch pressure regulation valves (not shown) reduce pressure on a designated NI clutch, thereby placing the transmission 14 into a partially-loaded “hydraulic neutral” state. Data necessary for an algorithm 100 resident within or accessible by an electronic control unit or a controller (C) 26 may be sampled and processed during other transmission settings, such as neutral (N) and park (P) as described below. The level of slip across the torque converter 16, or TC Slip, is equal to [N_{E}−N_{T}]. That is, when the TCC 31 is fully locked, N_{E}=N_{T}, and therefore TC Slip is zero, with some level of slip occurring below lockup speed.

Still referring to FIG. 1, the transmission 14 may be shifted into one of a number of settings, including drive (D), park (P), reverse (R), and neutral (N). Neutral idle (NI) may be directly entered when the transmission 14 is shifted to drive (D) or reverse (R). That is, when a PRNDL shifter device (not shown) is set to park (P) or neutral (N) while the engine 12 is running, the vehicle 10 is considered to be in a true neutral (N) mode. By way of contrast, neutral idle (NI) may be established when the transmission 14 of the vehicle 10 remains in drive (D) but the vehicle 10 is prevented from moving by application of a sufficient amount of braking force (arrow B) on a brake pedal 29B. The controller 26, or alternately a separate transmission controller, controls the transition between the various states using a plurality of different vehicle performance conditions.

Exemplary vehicle performance conditions may include, but are not necessarily limited to: vehicle speed (N), a value which can be directly measured by one or more sensors 39 shown separately in FIG. 1 for clarity, but which could be positioned as needed within the vehicle 10, e.g., at or along the output shaft 18 of the transmission 14 and/or at the road wheels 24, etc; throttle level (Th %) of a throttle input device such as an exemplary accelerator pedal 29A; braking level (B) such as travel and/or force applied to the brake pedal 29B; a predetermined PRNDL setting (S) of the transmission 14; a temperature (T_{Sump}) of the fluid 37 in the sump 35 of the transmission 14; etc.

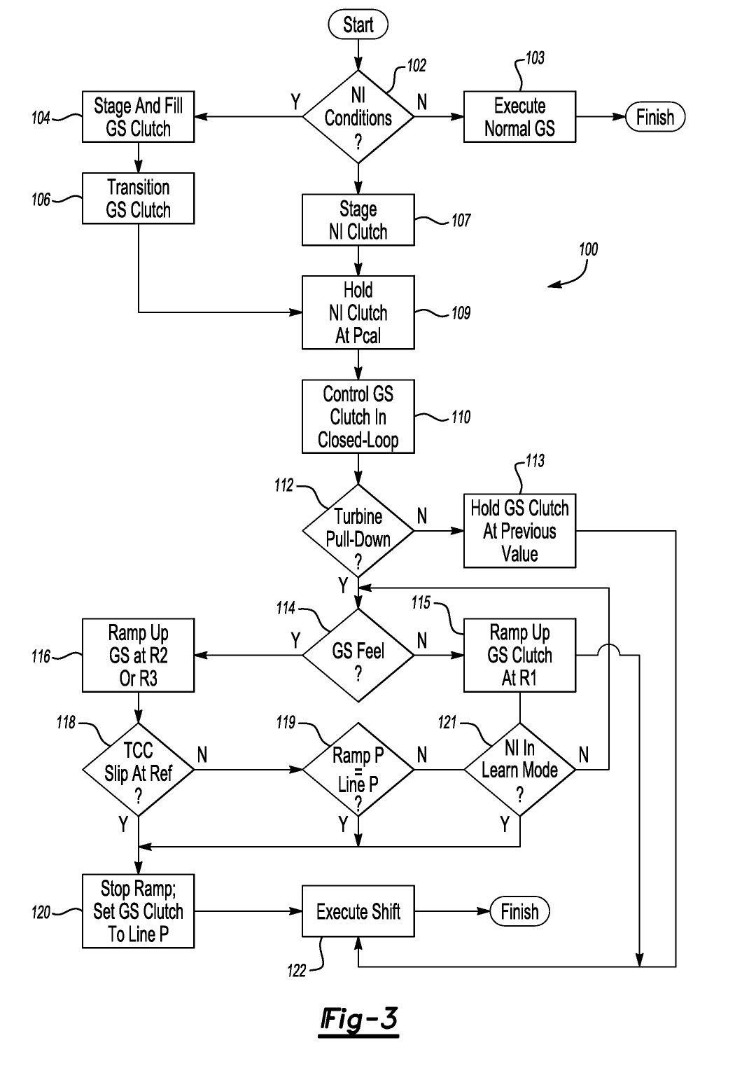

Still referring to FIG. 1, the engine 12 and the torque converter 16 are in communication with the controller 26, which is configured for storing and accessing the algorithm 100. The algorithm 100 in turn is specially adapted to execute the method of the invention as described below with reference to FIG. 3. The controller 26 can be configured as a microprocessor-based device having such common elements as a microprocessor or CPU, memory including but not limited to: read only memory (ROM), random access memory (RAM), electrically-programmable read-only memory (EPROM), etc., and circuitry including but not limited to: a high-speed clock (not shown), analog-to-digital (A/D) circuitry, digital-to-analog (D/A) circuitry, a digital signal processor or DSP, and the necessary input/output (I/O) devices and other signal conditioning and/or buffer circuitry. However configured, the controller 26 is operable for executing at least the algorithm 100 of FIG. 3 as needed to provide direct entry in an NI state during a garage shift (GS) event when the NI clutch is a separate device from the GS clutch as described below.

The controller 26 is configured for receiving, reading and/or measuring, calculating, and recording or storing various required measurements, values, or figures including any required readings fully describing the engine speed (N_{E}) and the transmission output speed (N_{O}), such as via one or more speed sensors 39 having an output speed or speeds labeled generically as N_{X}. The speed signals N_{E}, N_{O} are preferably transmitted electrically via conductive wiring, although any transmitting means such as, for example, radio frequency (RF) transmitters and receivers suitable for conveying or transmitting the required information to the controller 26, are also usable within the scope of the invention.

The torque converter 16 has a stator 30 disposed or positioned between a TC pump 32 or drive member and a turbine 34 or driven member. A lockup clutch or TCC 31 may also be used to selectively lock the pump 32 to the turbine 34 above a threshold lockup speed, as will be understood by those of ordinary skill in the art. The pump 32 may be bolted or otherwise directly connected to the output shaft 13 to thereby rotate at engine speed (N_{E}). Within the torque converter 16, the turbine 34 is driven by fluid 37, with the turbine 34 in turn connected to the input shaft 15 of the transmission 14. Thus, rotation of the turbine 34 ultimately rotates the input shaft 15 at a rate or a speed N_{T} less than or equal to the engine speed (N_{E}), with viscous drag or friction losses within the transmission 14 tending to reduce the turbine speed (N_{T}) to a level somewhat less than engine speed (N_{E}), as will be readily understood by those of ordinary skill in the art.

Referring to FIG. 2A, in one embodiment the transmission 14 shown in FIG. 1 is configured as an 8-speed transmission having a plurality of gear sets and clutches, i.e., the clutches and gears 17 of FIG. 1. In particular, a braking clutch CB1278R is provided that may be used to enter neutral idle. CB1278R is therefore referred to hereinafter for simplicity as the Neutral Idle (NI) clutch 36. The nomenclature CB1278R represents that this particular device is a braking clutch (CB), and is engaged in each of 1^{st}, 2^{nd}, 7^{th}, 8^{th}, and reverse (R) gears. The transmission 14 also includes another breaking clutch CB12345R, or clutch 41, which like the NI clutch 36 selectively connects an element of a first gear set 40 to a stationary member 28 when engaged. In another embodiment the braking clutch CB12345R may be engaged as an NI clutch in lieu of the NI clutch 36 to thereby enter neutral idle. Clutches 36 and 41 are connected to respective nodes 42 and 46 of first gear set 40. In one embodiment, node 42 can be a sun gear (S4) of the gear set 40, while node 46 may be a ring gear (R4) of the same gear set. Gear set 40 also includes a node 44, which may be a carrier member (PC4) in the embodiment shown.

Node 42 is also connected to a node 52 of a second gear set 50. Node 54 of gear set 50 is connected to an input side of a rotating clutch C13567, i.e., a garage shift or GS clutch 38, as is the transmission input shaft 15 with input torque (Tᵢₙ). Node 56 is connected to a third gear set 60 as explained below. In one embodiment, gear set 50 may be a planetary gear set wherein nodes 52, 54, and 56 are a sun gear (S1), a carrier member (PC1), and a ring gear (R1), respectively.

The third gear set 60 includes nodes 62, 64, and 66, which in one embodiment may be ring gear (R2), carrier member (PC2), and sun gear (S2), respectively. A rotating clutch C23468, i.e., clutch 58, may be connected between the output of GS clutch 38 and node 66, and between node 56 of gear set 50 and node 66 of gear set 60. Node 62 may be connected to a fourth gear set 70 having nodes 72, 74, and 76. In one embodiment, nodes 72, 74, and 76 may be a sun gear (S3), carrier member (PC3) and ring gear (R3), respectively. In particular, node 62 may be connected to node 72 via a rotating clutch C45678R, i.e., clutch 485. Node 64 of gear set 60 may be directly connected to node 74 of gear set 70, which in turn may be connected to the transmission output shaft 18 (also see FIG. 1). Before proceeding, it is noted that NI clutch 36 and GS clutch 38 are separate clutch devices, which when entering an NI state during a garage shift event will be controlled in different manners per the algorithm 100 described below with reference to FIG. 3.

Referring briefly to FIG. 2B, the transmission 14 of FIGS. 1 and 2A may also be embodied in a speed configuration other than the 8-speed transmission of FIG. 2A, such as a 6-speed configuration in the embodiment shown in FIG. 2B. In this embodiment, the transmission input shaft 15 may be connected to a first gear set 140 having nodes 142, 144, and 146, which may be embodied as a ring gear (R3), carrier member (PC3), and sun gear (S3) as shown. The input shaft 15 may be directly connected to node 142, and to a clutch C456, i.e., clutch 51. Node 144 is connected to a clutch C1234, i.e., the GS clutch 138, and to an input side of a rotating clutch C35R, i.e., clutch 53. Node 146 is grounded to the stationary member 28.

A second gear set 150 includes nodes 152, 154, 156, and 158, which may be embodied as a sun gear (S1), ring gear (R1), carrier gear (PC1), and another sun gear (S2), respectively. Node 154 is directly connected to the transmission output shaft 18. Node 156 is connected to a braking clutch CBR1, i.e., the NI clutch 136, which is also connected to a stationary member 28. As with the GS clutch 38 and NI clutch 36 in the embodiment shown in FIG. 2A, the GS clutch 138 and the NI clutch 136 are different clutch devices, which, when entering an NI state during a garage shift event, will be controlled in different manners per the algorithm 100.

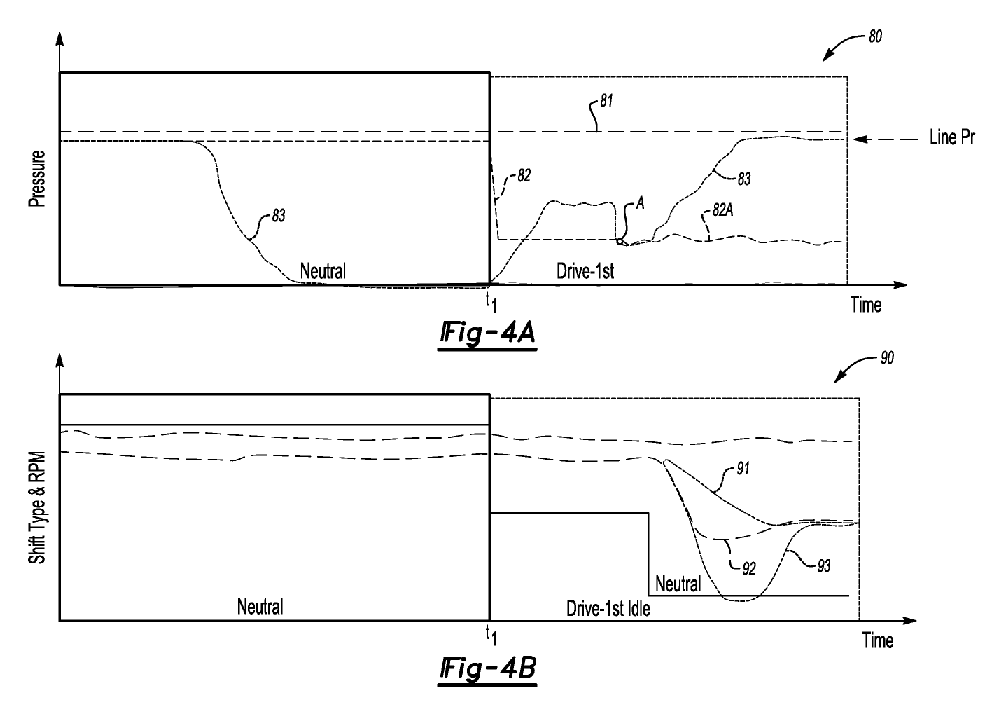

Referring to FIG. 3 in conjunction with the performance curves of FIGS. 4A and 4B, the algorithm 100 provides the ability to directly enter a neutral idle (NI) state during a garage shift when the garage shift clutch is not the neutral idle clutch, as is the case in the embodiments shown in FIGS. 2A and 2B described above. Generally, a neutral (N)-to-drive (D) or reverse (R) maneuver is performed to initiate the shift, with a PRNDL lever (not shown) of the vehicle 10 of FIG. 1 moved from P/N to D/R. The algorithm 100 therefore initiates only when a driver attempts this maneuver.

Beginning with step 102, the algorithm 100 determines whether neutral idle or NI conditions are met. NI conditions may include, but are not necessarily limited to, a transmission setting of drive (D), neutral (N), or reverse (R), whether the vehicle brake is on, whether throttle is at or sufficiently near zero, etc. If the required NI conditions are present, the algorithm 100 proceeds to steps 104 and 107 simultaneously, and otherwise proceeds to step 103.

At step 103, the algorithm 100 executes a “normal” garage shift. That is, referring briefly to FIG. 4A, the GS clutch pressure (line 83) and NI clutch pressure (line 82) are synchronized with line pressure (line 81), with the GS clutch 38, 138 filling and transitioning to closed-loop control during the normal garage shift. Once the garage shift is complete, the algorithm 100 is finished.

At step 104, having determined at step 102 that acceptable NI conditions are present, the GS clutch 38, 138 is staged and filled, i.e., all required fill or pressure controls are commanded on by the controller 26 of FIG. 1, and the GS clutch 38, 138 is filled to return pressure. The algorithm 100 proceeds to step 106.

At step 106, the algorithm 100 determines whether the fill of the GS clutch 38, 138 is complete, i.e., whether return pressure has been achieved, whether via direct measurement, calculation, or otherwise. Once filled, the algorithm 100 proceeds to step 109.

At step 107, the NI clutch 36, 136 is staged for regulation, i.e., filled to a predetermined return pressure, and then automatically transitioned to closed loop controls. Referring to FIG. 4A, at point A line 82A represents the closed-loop control or regulating of the NI clutch 36, 136, with point A being the transition point. Upon initiation of the garage shift at t₁, the clutch pressure of the NI clutch 36, 136 (line 82) drops down to a pre-learned pressure value (P_{CAL}) at a predetermined rate, then levels off to point A, with t₁ to point A describing the staging portion of the NI clutch 36, 136. At point A, i.e., the transition point, closed loop control is initiated over both the NI clutch 36, 136 and the GS clutch 38, 138. That is, after point A the clutches 36, 136 and 38, 138 are controlled in closed loop, with the GS clutch 38, 138 ramping up while the NI clutch 36, 136 is at a regulating pressure (line 82A). The algorithm 100 then proceeds to step 109.

At step 109, the NI clutch 36, 136 is held at P_{CAL}, and the algorithm 100 continues with step 110 wherein control of the GS clutch 38, 138 is transitioned over to closed-loop. Referring again to FIG. 4A, line 83 evens off at or near line pressure (line 81), whereupon closed loop control commences. Transition to closed loop control continues until it is determined at step 110 that the transition is complete, at which point the algorithm 100 proceeds to step 112.

At step 112, the algorithm 100 determines whether turbine pull-down is detected. As will be understood by those of ordinary skill in the art, turbine speed (N_{T}) is slowed by the oncoming clutch during a shift, causing slip in the off-going clutch. Turbine pull-down may be detected when turbine speed (N_{T} of FIG. 1) decreases a predetermined level below the transmission output speed (N_{O} of FIG. 1) multiplied by the higher speed ratio. The speed after shifting is referred to as synchronous speed, i.e., the pulled down turbine speed equals the transmission output speed (N_{O} of FIG. 1) multiplied by the lower speed ratio (SR), i.e., N_{T}=(N_{O})(SR). If such pull-down is detected, the algorithm 100 proceeds to step 114, otherwise proceeding to step 113.

At step 113, when turbine pull-down is not detected at step 112, GS clutch pressure is held at its previous value. The algorithm 100 proceeds to step 122.

At step 114, the algorithm 100 determines whether a particular garage shift or GS “feel” has been calibrated or programmed into the controller 26. Step 114 can be executed as part of a vehicle design or test process, e.g., a vehicle of a certain design being provided with a particular shift feel, or rapidity of turbine speed pull-down. Step 114 may also be executed during service of a vehicle in an aftermarket sense to provide a more customized driving experience. Regardless of how feel is set or programmed, if it has been programmed in the controller 26 the algorithm 100 proceeds to step 116, otherwise proceeding to step 115.

At step 115, GS clutch 38, 138 is ramped at a first rate (R1), as represented by the slope of line 83 in FIG. 4A. Turbine pull-down occurs at a reduced rate, as indicated by line 91 of FIG. 4B. The slope of line 91 is shallow relative to other possible ramps, e.g., lines 92 and 93, as explained below with reference to step 116. Once turbine pull-down is complete, and the algorithm 100 proceeds to step 122.

At step 116, the GS clutch 38, 138 is ramped at a faster rate (R2) relative to the rate (R1) described above with reference to step 115. Referring to FIG. 4B, R2 may be represented by either of lines 92 and 93. While only three lines 91, 92, and 93 are shown in FIG. 4B for simplicity, the number of possible ramp rates is not intended to be so limited, and may include more or fewer ramp options without departing from the intended scope of the invention. Algorithm 100 then proceeds to step 118.

At step 118, algorithm 100 determines whether TCC slip, i.e., slip across the torque converter 16 of FIG. 1, is within a calibrated or reference (REF) slip band over a calibrated time period. If so, the algorithm proceeds to step 120, otherwise proceeding to step 119.

At step 119, the algorithm 100 determines whether ramp pressure is equal to line pressure, i.e., whether in FIG. 4A line 83 is sufficiently equal to line 81. If so, the algorithm 100 proceeds to step 120, otherwise proceeding to step 121.

At step 120, ramping is stopped, and the GS clutch 38, 138 is set to line pressure (line 81 of FIG. 4A). The algorithm 100 then proceeds to step 122.

At step 121, the algorithm 100 determines whether an “NI learn mode” is active. As used herein, the term “NI learn mode” refers to the controlled slip being stable enough to learn the neural idle return pressure. If so, the algorithm 100 proceeds to step 120, otherwise returning to step 114.

At step 122, the garage shift maneuver is executed, and the algorithm 100 is finished. The controller 26 of FIG. 1 then resumes control of the transmission 14 using the necessary control logic (not shown).

While the best modes for carrying out the invention have been described in detail, those familiar with the art to which this invention relates will recognize various alternative designs and embodiments for practicing the invention within the scope of the appended claims.

1. A vehicle comprising:
an engine;
an automatic multi-speed transmission having a plurality of clutches, wherein the plurality of clutches may be selectively actuated to directly enter a neutral idle (NI) mode during a garage shift (GS) event; and
a controller having an algorithm adapted for controlling the transmission to directly enter the NI mode during the garage shift (GS) event, the GS event describing an automatic shift from one of a park (P), a neutral (N), and a reverse (R) setting to a drive (D) setting;
wherein one of the clutches is actuated as a non-slipping GS clutch during the GS event, and wherein another one of the clutches separate from the GS clutch is actuated as an NI clutch to directly enter the NI mode after completing the GS event.

2. The vehicle of claim 1, wherein the transmission is has at least six-forward speeds.

3. The vehicle of claim 1, wherein the plurality of clutches includes two braking clutches and three rotating clutches.

4. The vehicle of claim 3, wherein one of the braking clutches is the NI clutch, and wherein one of the rotating clutches is the GS clutch.

5. The vehicle of claim 1, wherein the controller is adapted for holding the NI clutch at a pre-learned NI pressure during a fill stage of the GS clutch.

6. The vehicle of claim 1, wherein the controller is operable for detecting turbine pull-down, and for varying the pull-down rate to provide different feels during the GS event.

7. An automatic multi-speed transmission for a vehicle comprising:
a plurality of clutches that are selectively actuated to directly enter a neutral idle (NI) mode during a garage shift (GS) event; and
a controller having an algorithm adapted for controlling the transmission, and to allow the transmission to automatically and directly enter the NI mode during a garage shift (GS) event, wherein the GS event is a shift from one of a park (P), a neutral (N), and a reverse (R) setting to a drive (D) setting;
wherein one of the clutches is actuated as a non-slipping GS clutch during the GS event, and wherein a different one of the clutches is actuated as an NI clutch to thereby directly enter the NI mode after completing the GS event.

8. The transmission of claim 7, wherein the transmission is one of a 6-speed transmission and an 8-speed transmission.

9. The transmission of claim 7, wherein the plurality of clutches includes two braking clutches and three rotating clutches.

10. The transmission of claim 8, wherein one of the braking clutches is the NI clutch, and wherein one of the rotating clutches is the GS clutch.

11. The transmission of claim 7, wherein the controller is adapted for holding the NI clutch at a pre-learned NI pressure during a fill stage of the GS clutch.

12. The transmission of claim 7, wherein the controller is operable for detecting turbine pull-down, and for varying the pull-down rate to provide different feels during the GS event.

13. A method for directly entering a neutral idle (NI) mode during a garage shift (GS) event from one of a park (P), a neutral (N), and a reverse (R) setting to a drive (D) setting using a multi-speed transmission, the method comprising:
using a controller to automatically actuate a first clutch of a plurality of clutches to complete the GS event; and
using the controller to automatically actuate a second clutch of the plurality of clutches to thereby directly enter the NI mode after completing the GS event;
wherein the first clutch is separate from the second clutch.

14. The method of claim 13, wherein the first clutch is a braking clutch and the second clutch is a rotating clutch.

15. The method of claim 13, further comprising holding the NI clutch at a pre-learned pressure during a full stage of the GS clutch.

16. The method of claim 13, further comprising detecting turbine pull-down, and then automatically varying the pull-down rate to provide different shift feels during the GS event.

17. The method of claim 13, further comprising controlling each of the NI clutch and the GS clutch in closed-loop during the NI mode until a predetermined set of exit conditions are met.
